(19) United States
(12) Patent Application Publication
(10) Pub. No.: US 2026/0086499 A1
(43) Pub. Date: Mar. 26, 2026

(54) HOLOGRAPHIC CIPHER MATRIX ENCRYPTION SYSTEM

(71) Applicant: Bank of America Corporation, Charlotte, NC (US)

(72) Inventors: Adam Kristian King, Fort Mill, SC (US); Stacy Ellis Ingle, Denver, NC (US)

(21) Appl. No.: 18/892,736

(22) Filed: Sep. 23, 2024

(51) Int. Cl. G03H 1/00; G03H 1/04; H04L 9/08

(52) U.S. Cl. CPC G03H 1/0011; G03H 1/0402; H04L 9/0861; G03H 2001/0441

(57) ABSTRACT

A method for encrypting data leveraging holographic technology. The method may include generating holographic interference patterns to produce encryption keys. The holographic patterns may be based on environmental conditions. The environmental conditions may be continuously monitored to generate the holographic interference patterns in real-time. The holographic interference patterns may be generated based on the environmental conditions and laser lights. The holographic interference patterns may be integrated into a computer infrastructure. The holographic interference may continuously adapt based on changes within an environment.

### FIELD OF TECHNOLOGY

Aspects of the disclosure relate to holographic technology and encryption systems.

### BACKGROUND OF THE DISCLOSURE

The internet is used for sharing and transmitting data. Sensitive information can be exposed during data transmission. People of malicious intent may utilize the exposed sensitive data. In order to prevent people of malicious intent from accessing and using the exposed sensitive data, data in transit is typically secured by one or more encryption mechanisms. Encryption (and decryption) mechanisms involve one or more keys. The data is converted (and deconverted) into non-decipherable data by combining the data with the one or more keys. The non-decipherable data is transmitted over a network, such as the internet. Many encryption techniques require that communicating parties both maintain a key to decipher/decrypt the encrypted data.

Encryption can also be used to protect data “at rest.” Data at rest includes information stored on computers and storage devices. In recent years, there have been numerous reports of confidential data being exposed through loss of laptops or backup drives. Encrypting data at rest protects data in the event that a computer or storage device hosting data is misappropriated.

As noted above, encryption is also used to protect data in transit. Data in transit includes data being transferred via networks, mobile phones, wireless intercom systems, Bluetooth® devices, automatic teller machines (“ATMS”) and/or any other suitable data transfer system. Unencrypted data in transit may be intercepted and retrieved in an unauthorized manner.

Traditional quantum computing and optical computing methods encrypt the data with algorithms and static structures. Because the encryption is static, a person of malicious intent may decipher one or more encryption keys and retrieve the data.

Therefore, it would be desirable to create an encryption system that changes dynamically.

It would be further desirable for such an encryption system to use holography to generate encryption keys.

It would be yet further desirable for such an encryption system to utilize light interference patterns.

It would be yet further desirable for such an encryption system to adapt to real-time environmental conditions and/or variables.

### SUMMARY OF THE DISCLOSURE

Apparatus, methods and systems for a holographic cipher matrix (“HCM”) encryption system are provided.

Methods may include generating encryption keys. Encryption is the process of transforming data in a way that limits decoding the data to specific parties. Communicating parties maintain one or more keys. The keys may be used by the communicating parties to decrypt the data. The encryption keys may be dynamically generated. The encryption keys may be generated using holography. As such, the encryption keys may be holographic encryption keys. The encryption keys may be generated by encoding information in dynamic holographic patterns. The encryption keys may be generated by the dynamic holographic interference patterns. The holographic interference patterns may be holographic matrices.

Methods may use optical interference to generate the encryption keys. The encryption keys may be generated through interference light waves. The interference light waves may be used to generate holographic interference patterns. Holographic interference patterns may be patterns of high entropy and randomness. As such, the holographic interference patterns may be non-reproducible patterns.

Coherent light sources may be used to produce holographic interference patterns. Coherent light sources may include laser diodes. Laser diodes are semiconductor devices. The laser diodes may emit coherent light when an electric current passes through the laser diodes. The laser diodes may be compact in size. The laser diodes may produce light at various wavelengths. Laser diodes may include single-mode diodes. Single mode diodes may provide a stable, coherent beam that may be used for creating the holographic interference patterns.

Coherent light sources may also include Helium-Neon (He-Ne) lasers. He-Ne lasers are gas lasers that use a mixture of helium and neon gases. The He-Ne lasers may produce coherent light beams. The wavelength of the laser beams produced from He-Ne lasers may measure 632.8 millimeters (“mm”), about 632.8 mm or any other suitable number. He-Ne lasers may provide a stable, high-quality coherent light source for generating the holographic interference patterns.

In some embodiments, the coherent light may be directed into an interferometer. The interferometer may be a Michelson interferometer, a Mach-Zehnder interferometer and/or any other suitable interferometer. An interferometer is an instrument in which the interference of two beams of light is employed to make precise measurements. Real-time adjustments to interferometer settings may dynamically change the interference patterns.

A Michelson interferometer may split a beam of coherent light into two paths using a beam splitter. The paths may be reflected and recombined to produce a pattern. The recombined patterns may be the interference patterns. Each interference pattern may be different. The path length distance of each interference pattern may be different. The phase in each pattern may be different. The alignment of the beams in each pattern may be different. The Michelson interferometer may further analyze interference patterns for generating encryption keys.

An interferometer may be a Mach-Zehnder interferometer. The Mach-Zehnder interferometer may split light into two paths. The Mach-Zehnder interferometer may modulate the laser beams into two paths. The Mach-Zehnder interferometer may measure the laser beams to create a dynamic interference pattern for generating the encryption keys. The interference pattern may be holographic. The holographic interference pattern be reconstructed. The holographic interference pattern may be non-reproducible. The holographic interference pattern may produce, or be used to produce, encryption keys. The data may be encoded as a three-dimensional interference pattern created by the laser beams.

In other embodiments, the coherent light may be directed into lenses. The lenses may be high-quality convex lenses, aspheric lenses and/or any other suitable lenses. The lenses may focus the laser beams of the coherent light. The lenses may shape the laser beams.

In such embodiments, the shaped laser beams may be further directed into mirrors. Mirrors may be dielectric mirrors, metallic mirrors and/or any other suitable mirrors. The mirrors may further direct the laser beams.

The directed laser beams may be transmitted to beam splitters. Beam splitters may be cube beam splitters, plate beam splitters and/or any other suitable beam splitters. The beam splitters may divide the laser beams into multiple paths. The multiple paths may be measured to produce the interference patterns.

In one or more embodiments, the laser beams and/or holographic interference patterns may be stored on holographic plates, photopolymers and/or any other suitable hardware or software. The holographic plates or photopolymers may create and record the dynamic holographic interference patterns.

Holographic plates may include silver halide emulsions, dichromatic gelatin (“DCG”) and/or any other suitable holographic plates. Photopolymers may be DuPont’s HRF-700X, advanced photopolymers and/or any other suitable photopolymers. Holographic plates and photopolymers may capture the interference patterns with high fidelity. Holographic plates and photopolymers may store the interference patterns with high fidelity.

The interference pattern may be created on the holographic plate. The interference pattern may be created on a photopolymer. The holographic patterns may be a measurement of a split laser beam. The holographic interference patterns may be used to generate encryption keys.

The holographic interference patterns may be stored compactly. Therefore, an increase of data may be stored. Multi-dimensional encoding and storage may be used to store the holographic interference patterns. Multi-dimensional encoding and storage may include holographic recording media, compact storage format and data density. Multi-dimensional encoding may embed keys across spatial, spectral and temporal dimensions.

The holographic interference patterns may be stored compactly. Compact storage may increase the amount of data holographic patterns stored. Multi-dimensional encoding and storage may be used to store the holographic interference patterns. Multi-dimensional encoding and storage may include holographic recording media, compact storage format and data density.

The compact storage format may leverage light interference and diffraction to compactly store the data. The holographic interference patterns may be encoded in a plurality of dimensions. The data density in holographic storage may allow for an increase in the amount of data storage within the system.

The holographic patterns may be stored in a plurality of storage locations. Storage locations may include optical disks, holographic storage units, integrated storage arrays and other suitable storage locations. Optical disks may be coated with holographic recording material. The optical disks may store multiple layers of holograms. Holographic storage units may read the holographic interference patterns. Holographic storage units may write the holographic interference patterns. Holographic storage units may convert the measurement of the laser beams into holographic interference patterns. Integrated storage arrays may be integrated into the HCM system to access the data. Integrated storage arrays may be integrated into the HCM system to retrieve the holographic interference patterns.

Methods may further include continuously monitoring environmental conditions. The information encoded in the holographic interference patterns may be the environmental conditions. The holographic interference pattern may be generated dynamically. As the environment changes, new laser beams may be created and measured to generate new holographic interference patterns. The environmental changes may occur in real-time. The environmental changes may include changes in light intensity, changes in temperature, changes in humidity, changes in air pressure and/or any other suitable changes. The holographic interference pattern may be generated dynamically, thereby causing the encryption keys to dynamically change. As such, the encryption keys may be secure.

Environmental sensors may be used to dynamically change the encryption keys. Environmental sensors may include light sensors, temperature sensors, air pressure sensors, humidity sensors and/or any other suitable sensors. The environmental sensors may sense a change in the environment. The changes may be processed. The coherent light sources may generate laser beams based on the changes in the environment. The laser beams may be measured generating new holographic patterns. As such, the holographic patterns may be dynamically generated as the environment changes.

Environmental sensors may include light sensors. Light sensors may include photodiodes. Photodiodes may be silicon photodiodes. Silicon photodiodes may be used to measure light intensity. Silicon photodiodes may be BPW34 silicon photodiodes. Photodiodes may convert light into an electrical current. The electrical current may be proportional to the intensity of the light. The photodiodes may sense a change in light intensity within the environment of the encryption keys. The photodiodes may produce an electrical current based on the change in the light intensity.

Light sensors may be charged coupled device (“CCD”) sensors. Light sensors may be Complementary Metal Oxide Semiconductor (“CMOS”) sensors and/or any other suitable light sensors. CCD/CMOS sensors may be a Sony® IMX183 sensor or any other suitable sensor. The CCD/CMOS sensors may capture detailed images. The CCD/CMOS may continuously capture data on light intensity distribution. The CCD/CMOS sensors may provide high-resolution input for pattern adjustments based on light intensity data. The high-resolution input may be used to dynamically generate the holographic interference pattern and/or the encryption keys.

Environmental sensors may include temperature sensors. Temperature sensors may include thermocouples. Thermocouples may be Type K thermocouples and/or any other suitable thermocouples. Type K thermocouples may measure temperature. Type K thermocouples may sense changes in temperature. Type K thermocouples may produce a voltage correlated to a difference in temperature. Temperature sensors may further include Resistance Temperature Detectors (“RTDs”). RTDs may change the resistance based on temperature. As such, RTDs may allow precise monitoring of changes in temperature. RTDs may sense changes in temperature. The resistance of the RTDs may be data used to generate the holographic interference patterns and/or encryption keys.

Environmental sensors may include humidity sensors. Humidity sensors may measure humidity based on changes in capacitance. Humidity sensors may include Sensirion SHT3x sensors and/or any other suitable humidity sensors. Humidity sensors may measure changes in humidity (within an environment). The humidity changes may be used to dynamically generate the holographic interference pattern and/or encryption keys.

Environmental sensors may include pressure sensors. Pressure sensors may convert atmospheric pressure changes into electrical signals. Pressure sensors may be Microelectromechanical systems (“MEMS”) based pressure sensors and/or any other suitable pressure sensors. MEMS-based pressure sensors may include a Bosch® BMP280 pressure sensor. Pressure sensors may sense changes of pressure in an environment. The changes of pressure may be used to dynamically generate the holographic interference pattern and/or the encryption keys.

Methods may include continuously collecting changes in environmental conditions. Real-time data processing units may be used to dynamically generate the holographic interference patterns and/or encryption keys. Real-time data processing units may include Field-Programmable Gate Arrays (“FPGAs”), Digital Signal Processors (“DSPs”) and/or any other suitable processing units. The FPGAs may be used for data processing. The FPGAs are programmable semiconductor devices that are configured to perform a plurality of tasks. The FPGAs may process, in real-time, the sensor data received from the environmental sensors. The FPGAs may generate the holographic interference patterns and/or encryption keys based on the sensor data. The FPGAs may be placed on the main processing board. The FPGAs may be placed near the environmental sensors. The FPGAs may be embedded in system hardware infrastructure. Embedding the FPGAs in system hardware infrastructure may enable processing the sensor data as the sensor data is received.

The FPGAs may continuously collect environmental changes from the environmental sensors. The FPGAs may aggregate the sensor data. The FPGAs may pre-process the sensor data. The FPGAs may apply an initial filter to the sensor data. The FPGAs may apply a transformation algorithm to the sensor data.

Real-time processing units may further include Digital Signal Processors (DSP). The DSPs are microprocessors that perform high speed numerical processing. The DSPs further analyze the sensor data. The DSPs may generate, based on the sensor data, the holographic interference patterns in real-time. The DSPs may be located on the main processing board. As such, the main processing board may include the DSPs and the FPGAs. The DSPs may be integrated into the same module as the FPGAs. The DSPs may be integrated into a module separate from the FPGAs within the system. As such, the sensor data may be processed as the sensor data is received.

The FPGAs may transmit the processed sensor data to the DSPs. The DSPs may perform calculations of the sensor data. The DSPs may perform a detailed analysis of the sensor data. A detailed analysis of the sensor data may include pattern recognition. The DSPs may analyze the sensor data to identify sensor data that may be used for adjustment to the holographic interference patterns. The DSPs may dynamically generate the holographic interference patterns and/or encryption keys. The real-time adjustments may be based on the detailed analysis. Based on the calculations, the DSPs may communicate with the HCM system to generate the interference patterns.

Methods may further include adjusting the encryption keys. The dynamic modulation may modify the interference patterns based on the sensor data. The dynamically changing holographic interference patterns may generate (or be used to generate) new encryption keys. The encryption keys may be adjusted using dynamic modulation. Dynamic modulation may use spatial light modulators (“SLMs”) and phase modulators to dynamically adjust the encryption keys. The dynamic modulation may adjust the light waves in real-time. Methods may continually update the holographic patterns to reflect real-time environmental changes. Therefore, the encryption keys may continually change.

Methods may include integrating the holographic interference patterns into computing infrastructures. The HCM system may be integrated into a computing infrastructure and/or applications. The computing infrastructure may be an existing infrastructure. The computing infrastructure may be a new infrastructure. The HCM system may be scalable. As such, the HCM system may be integrated into an existing computing infrastructure. The HCM system may be compatible with existing infrastructures. As such, the HCM system may be integrated into a plurality of applications. The plurality of applications may include data transmission applications, secure communication applications, cybersecurity applications and/or any other suitable application.

The HCM system may be compatible with standard networking protocols. Standard networking protocols may include Ethernet, Wi-Fi®, fiber optics and/or any other suitable standard networking protocols. The stored data may be stored within the computing infrastructure using storage protocols in various storage systems. Storage systems may include solid state drives (“SSDs”), hard disk drives (“HDDs”) and cloud storage platforms. The HCM system may interface with storage management software to store the holographic interference patterns and/or encryption keys. The HCM system may interface with storage management software to retrieve the holographic interference patterns.

An application programming interface (“API”) may be used to integrate the HCM system into a computer infrastructure. There may be a plurality of APIs that may be used to integrate the HCM system into the computer infrastructure. The APIs may include custom APIs. Custom APIs may enable seamless communication between the HCM system and existing applications. Custom APIs may include representational state transfer (“RESTful”) APIs, cross-platform high-performance Remote Procedure Call (“gRPC”) APIs and WebSocket APIs. RESTful APIs are used for web-based applications. The RESTful APIs may allow for secure data transmission between the HCM system and client applications. The gRPC APIs may be used for high-performance communication between microservices within cloud-native applications. WebSocket APIs provide a real-time data transfer capability for applications requiring instant updates and interaction with the HCM system.

The HCM system may use standard protocols and APIs to interface with current technology stacks. The APIs may use Software Development Kits (“SDKs”) to integrate the HCM system into the computer infrastructure. SDKs may be used for programming languages. Programming languages may include Python, Java, C++ and/or any other suitable programming language. The SDKs may integrate the HCM functionalities into software programs. As such, the system may be implemented on various platforms without the use of specialized hardware.

Methods may further include retrieving the holographic interference patterns. The holographic interference patterns may be retrieved through optical readout. The retrieved holographic interference patterns may be processed. The processing may decode the retrieved holographic interference patterns. The processed holographic interference patterns may be integrated into the HCM system.

Optical readout may be used to retrieve the holographic interference patterns. Coherent light sources may be used to retrieve the holographic interference patterns. The coherent light sources may read the stored holographic interference patterns. The coherent light sources may include laser diodes, He-Ne lasers and/or any other suitable lasers or coherent light sources. The coherent light sources may retrieve the holographic interference patterns by lighting up the holographic method.

Upon retrieving the stored holographic interference patterns, the holographic interference patterns may be reconstructed. Reconstructing the holographic interference patterns may include directing a reference beam onto the holographic medium used during the recording process. The reference beam may reconstruct the stored interference patterns. As such, the holographic interference patterns may be accessible and retrievable.

Upon reconstruction of the holographic interference patterns, the patterns may be decoded. The SLMs and phase modulators may be used to decode the holographic interference patterns. The SLMs and phase modulators may adjust the light waves to generate the recorded patterns. As such, retrieval of the holographic patterns may be accurate.

The reconstructed interference patterns may be processed. Data processing units may be used to process the reconstructed interference patterns. Data processing units may include FPGAs and DSPs. The FPGAs and DSPs may process the reconstructed pattern to retrieve the encoded encryption keys. The same environmental data may be retrieved to decode the holographic patterns. The FPGAs and DSPs may confirm that the retrieved data matches the real-time environmental conditions used during the recording. As such, the security of the data may be maintained.

Upon confirmation of the encrypted keys, the holographic interference pattern may be integrated into the HCM system. The HCM system may continuously adapt to adjust the system according to the environmental conditions. The environmental sensors may continuously monitor the environmental conditions. The environmental sensors may forward the retrieved data to the processing units. The holographic patterns may be dynamically generated in real-time. As the patterns are generated, the holographic patterns may be stored. Upon integration in the HCM system, the encryption keys may, at times, be retrieved. The HCM system may therefore use the same environmental data to decode the holographic patterns.

### BRIEF DESCRIPTION OF THE DRAWINGS

The objects and advantages of the invention may be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows an illustrative flow diagram in accordance with principles of the disclosure; and

FIG. 4 shows another illustrative flow diagram in accordance with principles of the disclosure.

### DETAILED DESCRIPTION OF THE DISCLOSURE

Apparatus, methods and systems for a Holographic Cipher Matrix (“HCM”) System are provided.

The HCM system may include a plurality of lasers. The lasers may be laser diodes, single-mode laser diodes, He-Ne lasers and/or any other suitable lasers. The lasers or laser diodes may generate laser beams. The laser beams may be a plurality of wavelengths. The wavelength of the beam may depend on the laser. The lasers may emit coherent light when an electrical current passes through them.

The HCM system may include a plurality of lenses. The lenses may be high-quality plano-convex and/or aspheric lenses. The laser beams may be input into the lenses. The lenses may focus the laser beams. The lenses may shape the laser beams.

The HCM system may include a plurality of mirrors. The mirrors may be dielectric mirrors, metallic mirrors and/or any other suitable mirrors. The shaped and focused laser beams may be transmitted to the mirrors. The mirrors may direct the laser beams. The mirrors may direct the laser beams.

The HCM system may further include a plurality of beam splitters. The beam splitters may be cube beam splitters, plate beam splitters and/or any other suitable beam splitters. The directed laser beams may be transmitted to the beam splitters. The beam splitters may divide the laser beams into multiple paths. The multiple paths may be used for generating holographic interference patterns.

The HCM system may include holographic plates and/or photopolymers. The holographic plates and/or photopolymers may be sensitive materials. The holographic plates may be silver halide emulsions, dichromatic gelatin (“DCG”) or any other suitable holographic plates. The photopolymers may be DuPont’s® HRF-700X, advanced photopolymers and/or any other suitable photopolymers. The holographic plates and photopolymers may store the multiple paths of the laser beams. The holographic plates and photopolymers may generate holographic interference patterns based on the multiple paths.

The HCM system may further include a plurality of encryption keys. The plurality of encryption keys may be based upon the holographic interference pattern. The encryption keys may be generated from the holographic interference patterns. The holographic interference patterns may be dynamically generated based on changes in the environment. Each of the holographic interference patterns may generate encryption keys.

The HCM system may include a plurality of environmental sensors. The environmental sensors may sense changes in an environment. The environmental changes may occur in real-time. The changes in the environment may generate laser beams. The laser beams may be measured to generate holographic interference patterns. The encryption keys may change dynamically, in real-time, as the environment changes.

The environmental sensors may include light sensors, temperature sensors, pressure sensors, humidity sensors and/or any other suitable sensors. The light sensors may sense an environmental change in light intensity. The temperature sensors may sense an environmental change in the temperature. The pressure sensors may sense an environmental change in the atmospheric pressure. The humidity sensors may sense an environmental change in the humidity. The environmental sensors may incorporate the environmental changes into laser beams.

The HCM system may include a plurality of real-time processing units. The real-time processing units may be FPGAs and DSPs. The FPGAs may process the data received from the environmental sensors. The FPGAs may aggregate the data received from the environmental systems. The FPGAs may apply an initial filtering to the sensor data. The FPGAs may apply transformation algorithms to the sensor data.

The pre-processed data may be transmitted to the DSPs. The DSPs may perform a detailed analysis of the data. Detailed analysis of the data may include pattern recognition. Detailed analysis may include real-time adjustments to generate the interference patterns. The real-time processing units may generate the holographic interference patterns based on the data received from the environmental sensors. The DSPs may communicate with the photopolymers and/or the holographic plates to adjust the interference patterns dynamically. As such, the HCM system may continuously process the data transmitted from the environmental sensors to dynamically change the encryption keys.

The HCM system may include an application programming interface (“API”). The HCM system may be integrated into computing infrastructures. The APIs may interface the HCM system with computing infrastructures. The API systems enable seamless communication between the HCM system and existing applications.

The HCM system may be deployed in telecommunication networks. As such, the HCM system may secure data packets transmitted over the internet or other networks. The APIs may allow the HCM system to work with existing encryption standards and protocols.

The HCM system may be integrated into messaging apps, VoIP services and/or other communication platforms. As such, an end-to-end encryption system may be provided. The APIs may facilitate seamless integration with existing security frameworks.

The HCM system may integrate with security information and event management (“SIEM”) systems, intrusion detection/prevention systems (“IDS/IPS”) and other cybersecurity implementations. As such, the HCM system may enhance cybersecurity measures in enterprise environments.

The HCM system may work alongside or as an alternative to quantum-resistant algorithms. As such, the HCM system may provide additional layers of security in a post-quantum computing era.

The HCM system may be integrated into an Internet of Things (“IoT”) device as a device security module. The HCM system can ensure secure data transmission and storage to or from an IoT device and/or within an IoT network. As such, the IoT device may be protected against cyber threats targeting connected devices.

The HCM system may be used to enhance security of a Blockchain system. By integrating with blockchain platforms, the HCM system may provide an additional layer of encryption for transactions and data stored on the blockchain. As such, the HCM system may ensure the tamper-proof quality of the records.

The HCM system may be used in autonomous systems to secure communication. Autonomous vehicles and drones may use the HCM system to secure communication and data sharing. As such, the data communicated to or from autonomous vehicles and drones may be protected against hacking and data breaches.

The HCM system may be used in an artificial intelligence and machine learning (“AI/ML”) engine to ensure data integrity. The HCM system may be used to secure the data used for training machine learning models. As such, the HCM system may ensure the integrity and confidentiality of sensitive information.

The HCM encryption system may adapt in real-time to changes in environmental conditions. Adaption to real-time environmental changes may ensure continuous security. Additionally, the HCM encryption system may provide resilience against emerging threats. The HCM system may dynamically generate the holographic interference patterns to maintain encryption integrity and confidentiality in dynamic operating environments. The holographic interference patterns may have varying spatial and temporal characteristics.

The HCM encryption system may use algorithms for adaption in systems and/or computer infrastructures. Algorithms may include machine learning (“ML”) algorithms. ML algorithms may include recurrent neural networks (“RNN”), long short-term memory (“LSTMs”) networks, random forests, support vector machines (“SVMs”) and/or any other suitable machine learning algorithms. RNN may be used to analyze time-series data from environmental sensors to predict future changes. Upon prediction of future changes, holographic patterns may be generated and/or adjusted accordingly.

LSTMs may be a type of RNN for learning long-term dependencies. As such, the HCM system may be able to react to gradual environmental changes.

Random Forests use multiple sensor inputs to perform real-time decision making. As such, the random forests may provide predictions of encryption keys and adjustments of encryption keys to maintain encryption integrity.

The HCM system may use one or more SVMs to classify and respond to several types of environmental conditions. As such, the SVMs may enable appropriate adjustments to be made within the HCM system. The adjustments may maintain encryptions integrity.

The HCM system may be continuously monitored with the light sensors, atmospheric sensors, pressure sensors and/or any other suitable sensors.

The computer infrastructure in which the HCM system is integrated may include a plurality of real-time data collection units. The software and hardware of the real-time data collection units may be designed to collect, preprocess and transmit sensor data to adaptive algorithms. As such, the algorithms may be adapted in a timely manner.

The HCM system may continuously monitor the environmental conditions. The monitored environmental conditions may be transmitted to the processing units. The adaptive algorithms may analyze the environmental condition data. The algorithms may detect patterns within the environmental condition data. The algorithms may predict changes based on the environmental condition data. The predicted changes may classify an environmental state and determine appropriate adjustments.

The HCM system may dynamically generate holographic patterns using spatial light modulators (“SLMs”) and phase modulators. The system may generate the holographic pattern based on the analysis. As such, the system may modify the light waves. The generation of the holographic patterns may be made in real-time. As such, the encryption keys may be continuously evolving. Continuously evolving keys may provide and/or maintain a high level of security.

The sensors may continually sense various environmental variables and/or conditions. The new sensor data may be continuously fed into the machine learning models. The predictions and adjustments may be refined based on the new input sensor data. The encryption keys may be generated based on current environmental conditions. The ongoing adjustment process may provide resilient and secure encryption keys.

Systems and methods described herein are illustrative. Systems and methods in accordance with this disclosure may now be described in connection with the figures, which form a part hereof. The figures show illustrative features of system and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Systems may omit features shown or described in connection with illustrative systems. Embodiments may include features that are neither shown nor described in connection with the illustrative systems. Features of illustrative systems may be combined. For example, an illustrative embodiment may include features shown in connection with another illustrative embodiment.

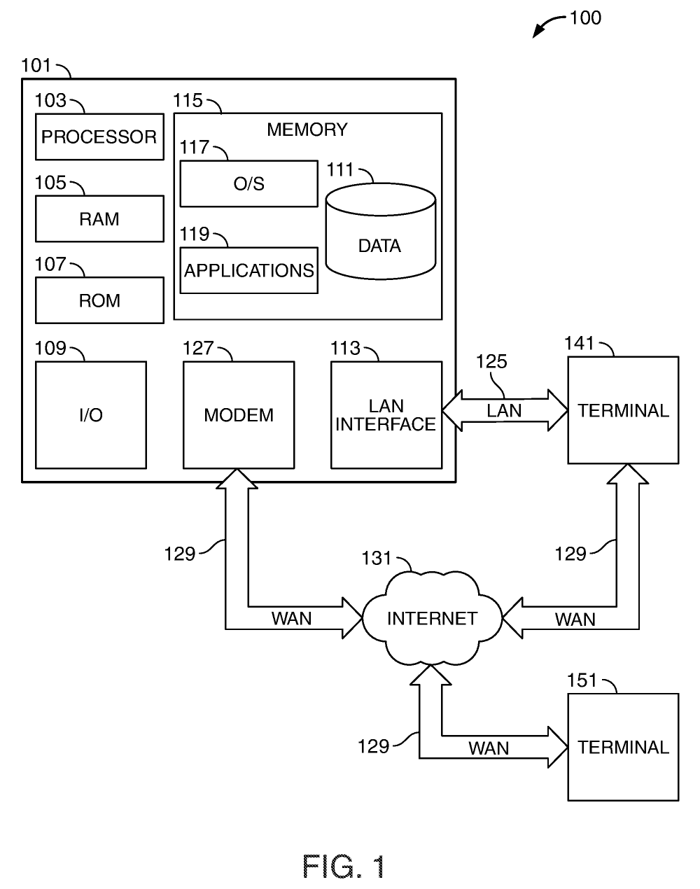

FIG. 1 shows an illustrative block diagram of apparatus 100 that includes a computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/ microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as an artificial intelligence implemented termination program and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as an artificial intelligence implemented termination program and security protocols) along with any other data 111 (e.g., historical data, configuration files) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, Wi-Fi, cellular networks, or other suitable frequencies.

Any memory may be comprised of any suitable permanent storage technology—e.g., a hard drive or other non-transitory memory. The memory may store software including an operating system and any application(s) (such as an artificial intelligence implemented termination program and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a world-wide network. “Cloud-based applications” generally refer to applications located on a server remote from a user, wherein some or all of the application data, logic, and instructions are located on the internet and are not located on a user’s local device. Cloud-based applications may be accessed via any type of internet connection (e.g., cellular or Wi-Fi).

Terminals 141 and 151 may be personal computers, smart mobile devices, smartphones, IoT devices, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, Wi-Fi, cellular networks or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an artificial intelligence implemented termination program and security protocols, as well as other programs. In an embodiment, one or more programs, or aspects of a program, may use one or more artificial intelligence/machine learning (“AI/ML”) algorithm(s). The various tasks may be related to terminating or preventing a malicious AI from completing its malicious activities.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

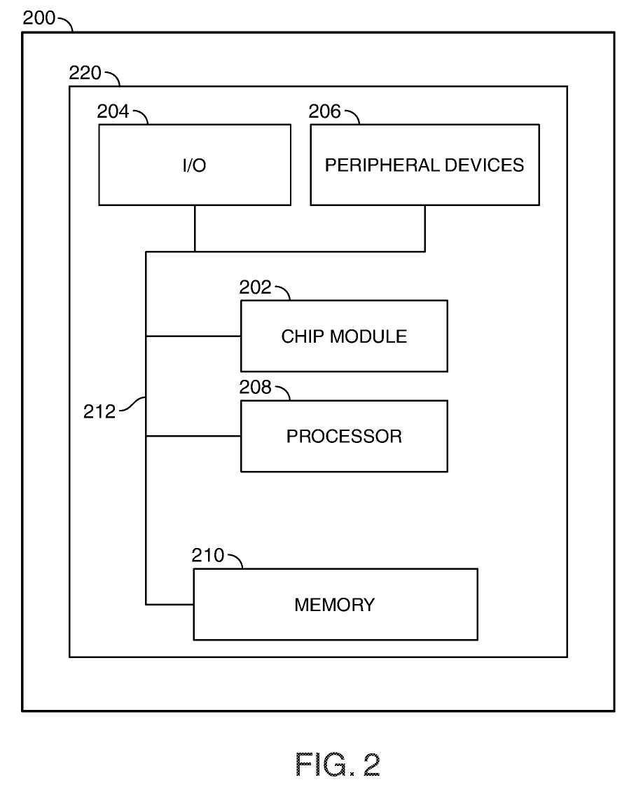

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-4. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 206, which may include other computers, logical processing device 208, which may compute data information and structural parameters of various applications, and machine-readable memory 210.

Machine-readable memory 210 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

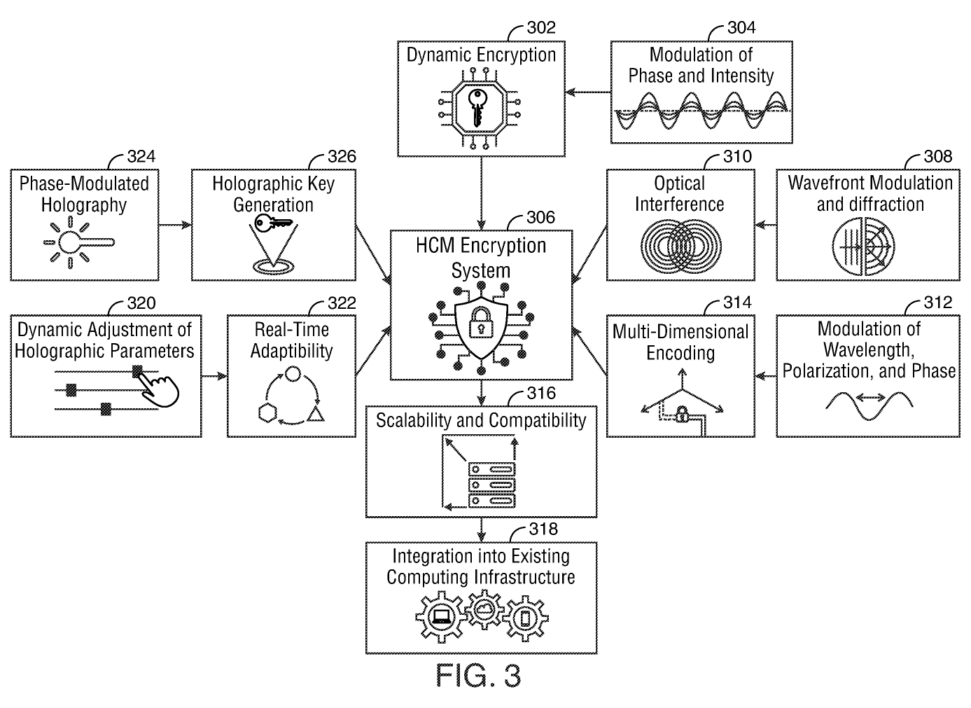

FIG. 3 shows a flow diagram of HCM encryption system 306.

Phase-modulated holography 324 may be used to generate encryption keys, as shown at 326. Phase-modulated holography may include generating dynamic holographic patterns from interfering laser beams. The interfered laser beams may be measured. The measurement may be used to generate holographic interference patterns. The holographic interference patterns may generate encryption keys.

The HCM system may modulate the phase and/or intensity of the laser beams, as shown at step 304. Upon modulation of the phase and/or intensity of the laser beams, holographic patterns with varying spatial and temporal characteristics may be generated. The holographic patterns may use dynamic holographic encoding techniques to dynamically generate the encryption keys, as shown at step 302.

Coherent light waves may be produced to generate the holographic interference patterns. The interference of the light waves may be generated with exploiting wavefront modulation and diffraction principles, as shown at step 308. The light waves may be generated through optical interference, as shown at step 310. The holographic interference patterns may have high entropy and randomness. As such, the HCM system may be secure.

Modulating wavelength, polarization and phase of the laser beams may be used when storing the holographic interference patterns with multi-dimensional encoding, as shown at steps 312 and 314. Multi-dimensional encoding may embed the encryption keys across spatial, spectral and temporal wavelengths. As such, security of the HCM system may be enhanced.

HCM encryption system 306 may be scalable and compatible with standard optical components and laser systems, as shown at step 316. HCM encryption system 306 may leverage standard optical components and laser systems. As such, HCM encryption system 306 may be integrated into an existing computing infrastructure, as shown at step 318. HCM encryption system 306 may be encrypted in a plurality of existing computing infrastructures or applications. HCM encryption system 306 may be integrated into a plurality of new computing infrastructures.

HCM encryption system 306 may dynamically adjust the holographic parameters in real-time, as shown in step 320. The holographic parameters may be used to dynamically generate the holographic interference patterns in real-time, as shown at step 322. Holographic parameters may include phase-modulation and interference patterns. The holographic interference patterns may be generated in real-time. Therefore, the keys may be adapted in real-time. As such, the keys may provide systems with an additional level of security.

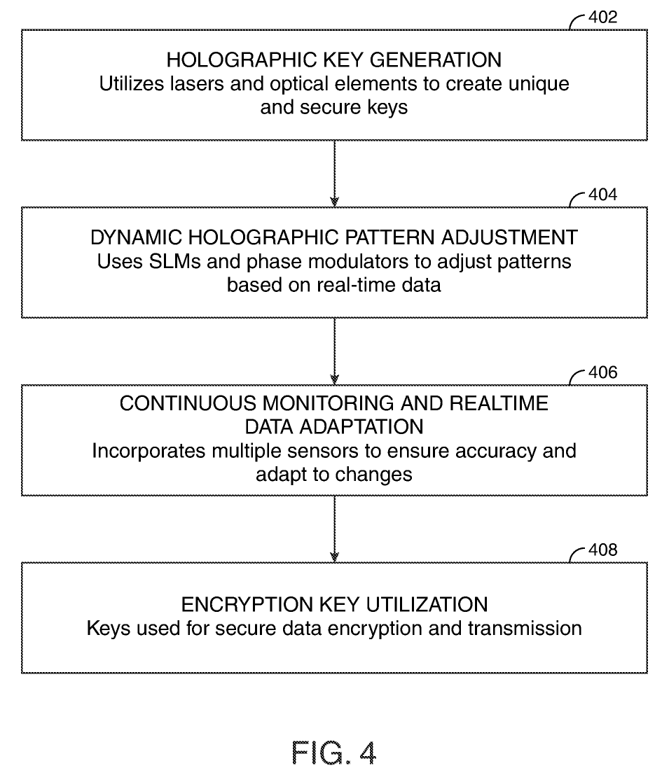

FIG. 4 shows an illustrative flow chart of the HCM encryption system. The HCM encryption system may generate holographic keys, as shown at step 402. The system may generate the keys using lasers and optical elements. The lasers and optical elements may generate laser beams. The laser beams may be measured. The measurements of the laser beams may be the holographic interference patterns.

The HCM encryption system may further include dynamic holographic pattern adjustments, as shown at step 404. The holographic pattern, from which the dynamic keys are created, may be dynamically adjusted and/or generated. There may be continuous monitoring systems that continuously monitor an environment surrounding the lasers and optical elements. The holographic patterns may be generated based on the continuously monitored environmental variables. The Spatial Light Modulators (SLMs) and phase modulators may generate the holographic interference patterns. Therefore, the keys may be dynamically adjusted to adapt to changing environmental conditions.

The HCM system may continuously monitor the environmental conditions and may adapt the holographic interference patterns in real-time, as shown at step 406. A plurality of sensors may continuously monitor holographic parameters, or environmental conditions. Sensors may include light sensors, temperature sensors, humidity sensors, pressure sensors, and/or any other suitable sensors. The data retrieved from the sensors may be processed in real-time. The system may adapt the holographic patterns based on the processed data.

The HCM encryption system may utilize the generated and adapted encryption keys, as shown at step 408. The dynamically adjusted and continually updated encryption keys may be used for secure data transmission.

Thus, systems and methods for holographic cipher matrix encryption systems are provided. Persons skilled in the art may appreciate that the present invention can be practiced by other than the described embodiments, which are presented for purposes of illustration rather than of limitation. The present invention is limited only by the claims that follow.

What is claimed is:

1. A method for encrypting data, said method leveraging holographic technology, the method comprising:
generating holographic interference patterns to produce encryption keys, said generating based on environmental conditions;
continuously monitoring environmental conditions, said continuously monitoring adjusting the holographic interference patterns in real-time;
dynamically adjusting the holographic interference patterns based on the continuously monitored environmental conditions;
integrating the holographic interference patterns into computing infrastructures, said integrating encrypting data; and
continuously adapting the holographic interference pattern based on changes in an environment.

2. The method of claim 1 wherein the holographic interference patterns are adapted in real-time, as the environmental conditions change.

3. The method of claim 1 wherein the encryption keys are generated using lasers and optical elements.

4. The method of claim 1 wherein the holographic interference patterns are dynamically adjusted using spatial light modulators (“SLM”) and/or phase modulators.

5. The method of claim 1 wherein the environmental conditions include light, temperature, humidity and/or pressure.

6. The method of claim 1 wherein the environmental variables are continuously monitored using light sensors, temperature sensors, humidity sensors and/or pressure sensors.

7. A Holographic Cipher Matrix (“HCM”) system for encrypting data, the system comprising:
a plurality of lasers, each of said lasers generating a laser beam;
a plurality of lenses, each of said lenses focusing and shaping the laser beams;
a plurality of mirrors, each of said mirrors to direct the laser beams;
a plurality of beam splitters, each of said beam splitters dividing the laser beams into multiple paths;
a plurality of holographic plates, the holographic plates configured to:
record each of a plurality of characteristics about the laser beams; and
create a holographic interference pattern based on each of the characteristics of the laser beams;
one or more encryption keys, each encryption key being generated based on the holographic interference pattern;
a plurality of environmental sensors, each of said environmental sensor configured to continuously monitor environmental conditions, said environmental conditions occurring within an environment of the HCM system;
a plurality of real-time processing units for dynamically changing the holographic interference pattern and/or the encryption keys, said dynamically changing being based on the monitored environmental conditions; and
an application programming interface (“API”) for integrating the HCM system into a computer infrastructure.

8. The system of claim 7 wherein the plurality of lasers further comprises Helium-Neon lasers and/or laser diodes.

9. The system of claim 7 wherein the plurality of lenses further comprises high-quality convex lenses or aspheric lenses.

10. The system of claim 7 wherein the plurality of mirrors further comprises dielectric mirrors or electric mirrors.

11. The system of claim 7 wherein the plurality of beam splitters further comprises cube beam splitters or plate beam splitters.

12. The system of claim 7 wherein the plurality of environmental sensors further comprises:
light sensors, temperature sensors, pressure sensors and/or humidity sensors.

13. The system of claim 12 wherein the light sensors further comprise Charged Couple Device (“CCD”) sensors and/or Complementary Metal Oxide Semiconductor (“CMOS”) sensors.

14. The system of claim 12 wherein the temperature sensors comprise thermocouples.

15. The system of claim 12 wherein the pressure sensors comprise a Microelectromechanical system (“MEMS”) based pressure sensor.

16. The system of claim 12 wherein the humidity sensors comprise a Sensirion SHT3x Humidity sensors.

17. A Holographic Cipher Matrix (“HCM”) system for encrypting data, the system comprising:
a plurality of lasers, each of said lasers configured for generating a laser beam;
a plurality of lenses, each of said lenses configured for focusing and shaping the laser beams;
a plurality of mirrors, each of said mirrors to direct the laser beams;
a plurality of interferometers, each of said interferometers for splitting the laser beams into two paths;
a plurality of holographic plates, the holographic plates configured for:
recording each of a plurality of characteristics about the laser beams; and
creating a holographic interference pattern based on each of the characteristics of the laser beams;
one or more encryption keys, each encryption key being generated based on the holographic interference pattern;
a plurality of environmental sensors, each of said environmental sensor configured to continuously monitor environmental conditions, said environmental conditions within an environment of the HCM system;
a plurality of real-time processing units for dynamically changing the holographic interference pattern and/or the encryption keys, said dynamically changing being based on the monitored environmental conditions; and
an application programming interface (“API”) for integrating the HCM system into a computer infrastructure.

18. The system of claim 17 wherein the plurality of lasers further comprises Helium-Neon lasers and/or laser diodes.

19. The system of claim 17 wherein the plurality of interferometers further comprises Michelson interferometers and/or Mach-Zehnder interferometers.

20. The system of claim 17 wherein the plurality of environmental sensors comprises light sensors, temperature sensors, pressure sensors and/or humidity sensors.
